(19) United States
(12) Patent Application Publication
(10) Pub. No.: US 2019/0258435 A1
(43) Pub. Date: Aug. 22, 2019

(54) RECEIPT PRINTER CAPABLE OF COMMUNICATING WITH INFORMATION TERMINAL

(71) Applicant: TOSHIBA TEC KABUSHIKI KAISHA, Tokyo (JP)

(72) Inventor: Norihisa SHIRAISHI, Numazu Shizuoka (JP)

(21) Appl. No.: 16/272,044

(22) Filed: Feb. 11, 2019

(30) Foreign Application Priority Data
Feb. 21, 2018 (JP) 2018-028807

(51) Int. Cl. G06F 3/12

(52) U.S. Cl. CPC G06F 3/1252; G06F 3/1292; G06F 3/1224; G06F 3/122

(57) ABSTRACT

A receipt printer includes a printing device, a communication interface configured to receive print data, a wireless communication module, and a processor. The processor is configured to control the printing device to print a receipt image on a receipt sheet based on the print data received by the communication interface, generate text receipt data representative of text data included in the print data received by the communication interface, and control the wireless communication module to wirelessly transmit the text receipt data.

### CROSS-REFERENCE TO RELATED APPLICATION

This application is based upon and claims the benefit of priority from Japanese Patent Application No. 2018-028807, filed on Feb. 21, 2018, the entire contents of which are incorporated herein by reference.

### FIELD

Embodiments described herein relate generally to a receipt printer capable of communicating with an information terminal.

### BACKGROUND

In an electronic receipt system, an electronic receipt server manages an electronic receipt data converted by digitizing information on a paper receipt issued by printing a sales-transaction thereon. A customer uses an information terminal to access the electronic receipt server, and thus the customer can view the electronic receipt data (information on the paper receipt) on the information terminal.

Such an electronic receipt system may typically require the electronic receipt server. To provide the above service, it is necessary to replace a device such as a point-of-sale (POS) terminal issuing the paper receipt with a device having a function of transmitting the electronic receipt data to the electronic receipt server. For that reason, an initial cost of introducing the system may increase. Under these circumstances, it is desirable to provide an electronic receipt service at a lower cost.

### DESCRIPTION OF THE DRAWINGS

FIG. 1 is a block diagram illustrating a main circuit configuration of a receipt printer according to an embodiment.

FIGS. 2 and 3 are flowcharts illustrating information processing by a processor provided in the receipt printer in FIG. 1.

FIG. 4 is a flowchart illustrating information processing by a processor provided in an information terminal in FIG. 1.

### DETAILED DESCRIPTION

According to an embodiment, a receipt printer includes a printing device, a communication interface configured to receive print data, a wireless communication module, and a processor. The processor is configured to control the printing device to print a receipt image on a receipt sheet based on the print data received by the communication interface, generate text receipt data representative of text data included in the print data received by the communication interface, and control the wireless communication module to wirelessly transmit the text receipt data.

Hereinafter, an example of embodiment is described with reference to the accompanying drawings.

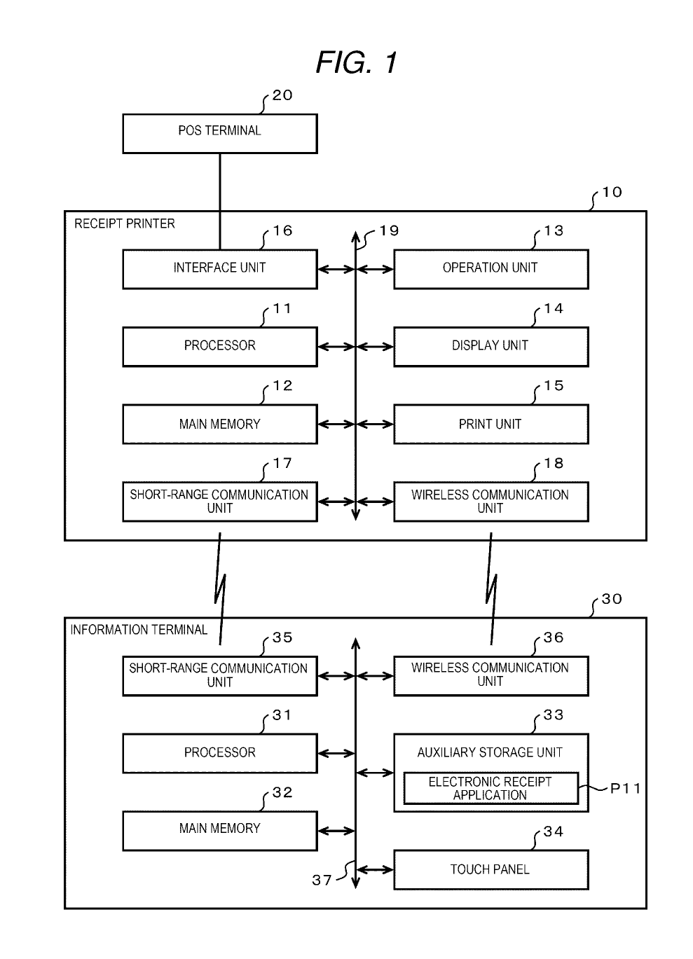

FIG. 1 is a block diagram illustrating a main circuit configuration of a receipt printer 10 according to the embodiment.

The receipt printer 10 is connected to a POS terminal 20 to issue a paper receipt in response to a print-request from the POS terminal 20. In addition, the receipt printer 10 is equipped with a function of transmitting information to be printed on the paper receipt to an information terminal 30 as electronic data.

The receipt printer 10 includes a processor 11, a main memory 12, an operation unit 13, a display unit 14, a print unit 15, an interface unit 16, a short-range communication unit 17, a wireless communication unit 18, and a transmission path 19. The processor 11, the main memory 12, the operation unit 13, the display unit 14, the print unit 15, the interface unit 16, the short-range communication unit 17, and the wireless communication unit 18 are connected via the transmission path 19.

In the receipt printer 10, a computer, performing information processing for controlling the receipt printer 10, which is composed of the processor 11 and the main memory 12 connected via the transmission path 19. The receipt printer 10 may further include an auxiliary storage unit connected to the transmission path 19, and the computer may include the auxiliary storage unit as auxiliary storage. As the auxiliary storage unit, for example, an electric erasable programmable read-only memory (EEPROM) is used. A hard disc drive (HDD), solid state drive (SSD), or the like can also be applied as the auxiliary storage unit.

The processor 11 serves as a central functional module of the computer. The processor 11 controls each unit to perform various functions as the receipt printer 10 according to an operating system, a firmware, and an application program.

The main memory 12 serves as main storage of the computer. The main memory 12 includes a nonvolatile memory region and a volatile memory region. The main memory 12 stores the operating system, the firmware, and the application program in the nonvolatile memory region. The main memory 12 may store data necessary for executing processing by the processor 11 to control each module of the computer in the nonvolatile or volatile memory region. The main memory 12 uses the volatile memory region as a work area where data is appropriately rewritten by the processor 11.

The operation unit 13 receives an operation by an operator. The operation unit 13 appropriately includes various operation devices such as a touch panel, a keyboard, and a key switch.

The display unit 14 performs a display for indicating various kinds of information to the operator. The display unit 14 may include various display devices such as a touch panel, an LED lamp, and a liquid crystal display panel.

The print unit 15 prints an image indicating a receipt on a receipt paper.

The POS terminal 20 is connected to the interface unit 16 via, for example, a communication cable. The interface unit 16 performs transmission/reception of various data with the POS terminal 20. As the interface unit 16, an existing device conforming to a well-known standard such as a universal serial bus (USB) can be used, for example.

The short-range communication unit 17 performs a wireless communication with the information terminal 30. As the short-range communication unit 17, an existing device conforming to a well-known communication standard such as a near field communication (NFC) can be used, for example.

The wireless communication unit 18 performs a wireless communication with the information terminal 30. The wireless communication unit 18 has a longer communicable distance and a higher communication speed compared with those of the short-range communication unit 17. For example, an existing communication device conforming to a well-known communication standard such as IEEE802.11g can be used as the wireless communication unit 18.

The transmission path 19 includes an address bus, a data bus, a control signal line, and the like, to transmit data and control signals transmitting or receiving between respective connected units.

The information terminal 30 includes a processor 31, a main memory 32, an auxiliary storage unit 33, a touch panel 34, a short-range communication unit 35, a wireless communication unit 36, and a transmission path 37. The processor 31, the main memory 32, the auxiliary storage unit 33, the touch panel 34, and the wireless communication unit 36 are connected via the transmission path 37.

In the information terminal 30, a computer, which performs information processing for controlling the information terminal 30, is composed of the processor 31, the main memory 32, and the auxiliary storage unit 33 connected via the transmission path 37.

The processor 31 serves as a central functional module of the computer. The processor 31 controls each unit to perform various functions as the information terminal 30 according to an operating system, a firmware, and an application program.

The main memory 32 serves as main storage of the computer. The main memory 32 includes a nonvolatile memory region and a volatile memory region. The main memory 32 stores the operating system, the firmware, and the application program in the nonvolatile memory region. The main memory 32 may store data necessary for executing a processing by the processor 31 to control each module of the computer in the nonvolatile or volatile memory region. The main memory 32 uses the volatile memory region as a work area where data is appropriately rewritten by the processor 31.

The auxiliary storage unit 33 serves as an auxiliary storage of the computer. The auxiliary storage unit 33 is, for example, an EEPROM. An HDD, an SSD, or the like can also be applied as the auxiliary storage unit. The auxiliary storage unit 33 stores data used by the processor 31 for performing various processing and data generated by processing by the processor 31. The auxiliary storage unit 33 stores the application problem.

One of the application programs stored in the auxiliary storage unit 33 is an information processing program (hereinafter referred to as an electronic receipt application program) P11 describing information processing for utilizing the electronic receipt service including an operation described below in cooperation with the receipt printer 10. However, in many cases, the electronic receipt application program P11 is downloaded, for example, via an Internet and written in the auxiliary storage unit 33 in response to an operation by a user of the information terminal 30. In other words, transfer of the information terminal 30 to the user is performed in a state in which the electronic receipt application program P11 is not stored in the auxiliary storage unit 33. However, the information terminal 30 with the electronic receipt application program P11 stored in the auxiliary storage unit 33 or the main memory 32 may be transferred to the user.

The touch panel 34 functions as an input device and a display device of the information terminal 30.

The short-range communication unit 35 of the information terminal 30 performs a wireless communication with the short-range communication unit 17 of the receipt printer 10 if the short-range communication unit 35 locates within a communication range of the short-range communication unit 17. For example, an existing communication device conforming to the same communication standard as the short-range communication unit 17 can be used as the short-range communication unit 35.

If the wireless communication unit 36 locates within the communication range of the wireless communication unit 18, the wireless communication unit 36 performs a wireless communication with the wireless communication unit 18. For example, an existing device conforming to the same communication standard as the wireless communication unit 18 can be used as the wireless communication unit 36.

The transmission path 37 includes an address bus, a data bus, and a control signal line, to transmit data and control signals received/transmitted between respective connected units.

An existing portable information processing device such as a smartphone or a tablet terminal, which can be carried by a shopper at the time of visiting the store, as hardware of the information terminal 30.

The operation of the receipt printer 10 configured as described above is described below together with a related operation of the information terminal 30.

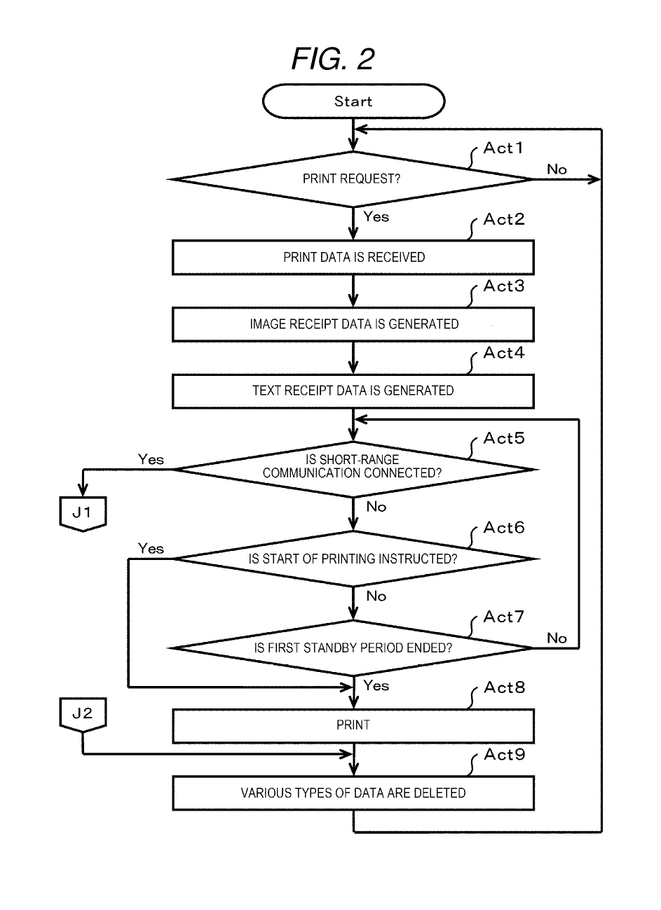

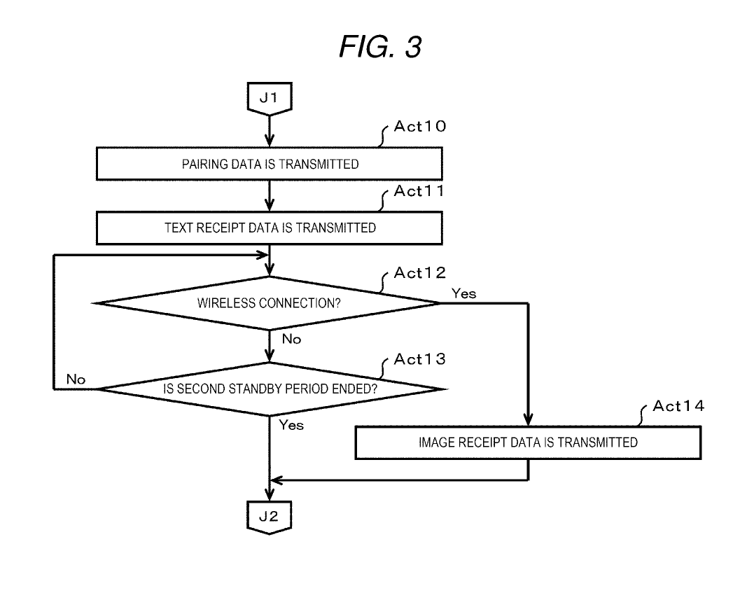

If the receipt printer 10 is in an operation state of issuing a receipt in response to a request from the POS terminal 20, the processor 11 executes the following information processing according to the firmware or the application program stored in the main memory 12. FIGS. 2 and 3 are flowcharts illustrating information processing by the processor 11.

In Act1, the processor 11 waits for a print request from the POS terminal 20. If the print request is received from the POS terminal 20, the processor 11 determines that YES is taken and the process proceeds to Act2.

In Act2, the processor 11 receives print data transmitted from the POS terminal 20 through the interface unit 16. The print data includes text data and image data indicating the character string and the image to be printed on the receipt. The character string to be printed on the receipt includes a store name, a shop location, a shop phone number, a transaction date and time, a commodity name, a unit price, a discount amount, a total amount, a consumption tax amount, the number of commodities, a settlement method, and the like. The image indicated by the image data includes an image printed on the receipt such as a store logo and an advertisement. It is arbitrary determined what kind of the text data and the image data is included in the print data. The processor 11 saves the received print data in the main memory 12. In this way, the processor 11 executes the information processing illustrated in FIGS. 2 and 3 and thus the computer having the processor 11 as the central part realizes a function as an acquiring module in cooperation with the interface unit 16.

In Act3, the processor 11 generates image receipt data, including various character strings and images indicated in the print data, and indicating images to be printed on the receipt sheet. The image receipt data is electronic receipt data indicating an appearance of the paper receipt in a form of the image data. The processor 11 saves the generated image receipt data in the main memory 12. In this way, the processor 11 executes the information processing illustrated in FIGS. 2 and 3 and thus the computer having the processor 11 functions as a second generating module.

In Act4, the processor 11 generates the text receipt data. Specifically, the processor 11 extracts the character strings from the print data and compiles the character strings in a predetermined format such as, for example, comma separated values (CSV) format to generate the text receipt data. The processor 11 extracts, for example, all the character strings indicated by the print data. However, the processor 11 may extract, for example, character strings relating to only predetermined items excluding some items such as the shop location. In other words, the text receipt data is the electronic receipt data in a form in which text data relating to a predetermined character string in the character strings indicated in the receipt is included but an image data is not included. The processor 11 saves the generated text receipt data in the main memory 12. In this way, the processor 11 executes the information processing illustrated in FIGS. 2 and 3, and thus the computer having the processor 11 as the central part functions as a first generating module.

In Act5, the processor 11 determines whether or not the short-range communication unit 17 is connected for short-range wireless communication. The processor 11 determines No if the connection is not performed and the process proceeds to Act6.

In Act6, the processor 11 determines whether or not start of the print is instructed. The processor 11 determines No if the instruction is not received and the process proceeds to Act7.

In Act7, the processor 11 determines whether or not a first standby period is ended. The processor 11 sets, as the first standby period, a period of time from a predetermined timing such as a point at the time the print request is received or a point at the time reception of the print data is completed until a predetermined standby time elapses. The start timing of the first standby period and the first standby time may be arbitrarily determined by a creator or a designer of the firmware or the application program described in relation to the information processing illustrated in FIG. 2. The processor 11 determines No if the first standby period is ended.

In this way, in Act5 to Act7, the processor 11 waits for the connection being performed for the short-range wireless communication or the start of printing is instructed, until the first standby period is ended.

The store clerk who operates the POS terminal 20 determines whether or not the shopper wants to receive a paper receipt or an electronic receipt service, and instructs the start of printing by a predetermined operation on the operation unit 13 if the shopper wants to receive the paper receipt. Then, the processor 11 determines Yes in Act6 and the process proceeds to Act8. An operation for instructing the start of the printing is performed through the operation unit provided in the POS terminal 20 and the instruction may be notified from the POS terminal 20 to the processor 11 via the interface unit 16. The operation for instructing the start of the printing may be performed by the shopper.

The processor 11 determines Yes in Act7 if the first standby period is ended in a state in which the connection for the short-range wireless communication is not performed or instruction of the start of the printing is not received, and the process proceeds to Act8.

In Act8, the processor 11 activates the print unit 15 to print an image on the receipt sheet based on the image receipt data generated in Act3. In this way, the processor 11 executes the information processing illustrated in FIGS. 2 and 3, and thus the computer having the processor 11 as the central part functions as a printing module in cooperation with the print unit 15.

In Act9, the processor 11 deletes each of the print data, the image receipt data, and the text receipt data saved in the main memory 12. Thereafter, the processor 11 returns to the standby state in Act1.

To receive the electronic receipt service provided by the receipt printer 10, the shopper activates the electronic receipt application program P11 in the information terminal 30 carried by the shopper. Then, the processor 31 executes information processing described below according to the electronic receipt application program P11.

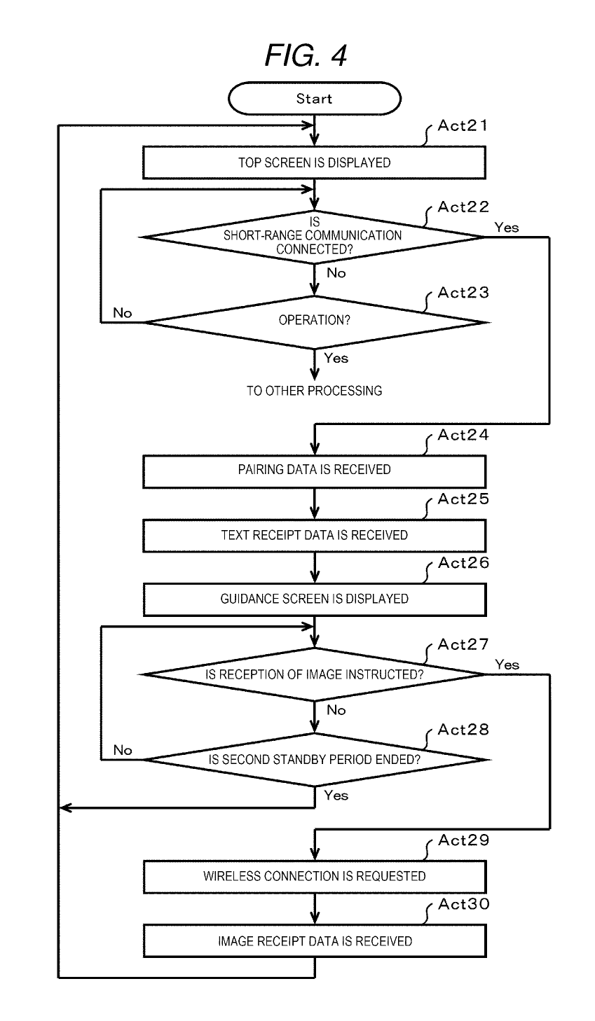

FIG. 4 is a flowchart illustrating the information processing by the processor 31.

In Act21, the processor 31 displays a top screen on the touch panel 34. The top screen indicates a message instructing the operator to hold his or her information terminal 30 over the receipt printer 10 so that the information terminal 30 acquires the text receipt data. The shopper holds the information terminal 30 over the receipt printer 10 in which the processor 11 is in the standby state in Act5 to Act7 in FIG. 2 according to the instruction in the message. Therefore, if the short-range communication unit 35 enters a communication range of the short-range communication unit 17, the mutual connection is established by the short-range communication unit 17 and the short-range communication unit 35. The short-range communication unit 17 and the short-range communication unit 35 correspondingly notify the processor 11 and the processor 31 that the connection is established. Upon receiving the notification of connection, the processor 11 determines Yes in Act5 in FIG. 2 and the process proceeds to Act10 in FIG. 3.

In Act10, the processor 11 transmits pairing data for wireless communication from the short-range communication unit 17 so that the wireless communication is performed through the wireless communication unit 18. The pairing data includes a service set identifier (SSID) and a passphrase if a communication standard to which the wireless communication unit 18 conforms is IEEE802.11g.

In Act11, the processor 11 transmits the text receipt data generated in Act4 through the short-range communication unit 17. The text receipt data may be transmitted in a state in which a compression processing for reducing data amount is performed. Thus, the short-range communication unit 17 serves as a first wireless communication device performing transmission of the text receipt data. In addition, the information processing illustrated in FIGS. 2 and 3 is executed by the processor 11, and thus the computer having the processor 11 as the central part functions as a transmission control module for controlling the first wireless communication device to perform the transmission of the text receipt data. The processor 11 performs a function as the transmission module for transmitting the text receipt data in cooperation with the short-range communication unit 17.

In the information terminal 30, the processor 31 displays the top screen in Act21 in FIG. 4 and the process proceeds to Act22 thereafter.

In Act22, the processor 31 determines whether or not the connection for the short-range wireless communication by the short-range communication unit 35 is established. The processor 31 determines No if the connection is not established, and the process proceeds to Act23.

In Act23, the processor 31 determines whether or not an operation such as an instruction to start browsing of the electronic receipt is performed, for example, on the touch panel 34. The processor 31 determines No if the operation is not performed, and the process returns to Act22.

Thus, in Act22 and Act23, the processor 31 waits for the connection for the short-range wireless communication being established or an operation being performed.

As described above, the processor 31 determines Yes in Act22 in FIG. 4 if the notification of the connection is received from the short-range communication unit 35, and the process proceeds to Act24.

In Act24, the processor 31 receives the pairing data. Specifically, as described above, if the pairing data transmitted from the short-range communication unit 17 is received by the short-range communication unit 35, the processor 31 saves the pairing data in the main memory 32 or the auxiliary storage unit 33.

In Act25, the processor 31 receives the text receipt data. Specifically, as described above, if the text receipt data transmitted from the short-range communication unit 17 is received by the short-range communication unit 35, the processor 31 saves the text receipt data in the auxiliary storage unit 33.

In Act26, the processor 31 displays a guidance screen on the touch panel 34. The guidance screen indicates a graphical user interface (GUI) for instructing reception of the image receipt data and also indicates a message for instructing an operation on the GUI to receive the image receipt data.

In Act27, the processor 31 determines whether or not the reception of the image receipt data is instructed. The processor 31 determines No if the instruction is not performed, and the process proceeds to Act28.

In Act28, the processor 31 determines whether or not a second standby period is ended. The processor 31 sets, as the second standby period, a period of time from a predetermined timing such as a point at the time the reception of the text receipt data is completed until a predetermined standby time elapses. The start timing of the second standby period and the second standby time may be arbitrary determined by the creator or designer of the firmware or the application program described for the information processing illustrated in FIG. 2. The processor 31 determines No if the second standby period is ended, and the process returns to Act27.

Thus, in Act27 and Act28, the processor 31 waits that the reception of the image receipt data is instructed, until the second standby period is ended.

If the shopper wants to receive the image receipt data, the shopper operates the GUI for instructing the reception of the image receipt data according to the guidance on the guidance screen. The processor 31 determines Yes in Act27 and then, the process proceeds to Act29.

In Act29, the processor 31 requests the wireless connection using the pairing data received in Act24 through the wireless communication unit 36.

In the receipt printer 10, if the wireless communication unit 18 receives the request of the wireless connection, the wireless communication unit 18 performs the connection for wireless communication with the wireless communication unit 36. If the wireless connection is completed, the completion of the connection is notified to the processor 11.

In Act11 in FIG. 3, the process proceeds to in Act12 if the processor 11 finishes the transmission of the text receipt data.

In Act12, the processor 11 determines whether or not the wireless connection is established. If the wireless connection is not established, the processor 11 determines No, and the process proceeds to Act13.

In Act13, the processor 11 determines whether or not the second standby period is ended. The processor 11 determines No if the second standby period is ended, and then the process returns to Act12.

Thus, in Act12 and Act13, the processor 11 waits for the wireless connection being established until the second standby period is ended.

As described above, the processor 11 determines Yes in Act12 if completion of the wireless connection is notified from the wireless communication unit 18, and then the process proceeds to in Act14.

In Act14, the processor 11 transmits the image receipt data generated in Act3 from the wireless communication unit to the wireless communication unit 36 through the wireless connection. Moreover, the processor 11 performs the compression processing for reducing the data amount of the image receipt data and transmits the compressed image receipt data thereafter. For example, the processor 11 generates the image receipt data in a bitmap format in Act3 and transmits the image receipt data after converting the image receipt data to the data in JPEG format in Act14. Thus, the wireless communication unit 18 serves as a second wireless communication device performing the transmission of the image receipt data. In addition, the processor 11 executes the information processing illustrated in FIGS. 2 and 3, and the computer having the processor 11 functions as a transmission control module for controlling the second wireless communication device to perform the transmission of the image receipt data. The processor 11 performs a function as the transmission unit for transmitting the image receipt data in cooperation with the short-range communication unit 17.

If the processor 11 finishes the transmission of the image receipt data, the process proceeds to Act9 in FIG. 2, and Act9 and the subsequent processing are executed in the same manner as described above. The processor 11 deletes each of the print data, the image receipt data, and the text receipt data saved in the main memory 12, and then returns to the standby state in Act1.

The processor 11 determines Yes in Act13 if the second standby period is ended without establishing the wireless connection, and the processing 11 passes the processing in Act14, and the process proceeds to in Act9 in FIG. 2. That is, the processor 11 returns to the standby state in Act1 without performing the transmission of the image receipt data.

If the process proceeds from Act13 or Act14 to Act9, the processor 11 does not perform printing in Act8. If the printing is performed in Act8, the processor 11 does not perform the transmission of the text receipt data and the image receipt data in Act11 and Act14. Thus, the processor 11 executes the information processing illustrated in FIGS. 2 and 3, and the computer having the processor 11 functions as an output control module.

In the information terminal 30, the processor 31 requests the wireless connection in Act29 in FIG. 4, and then the process proceeds to Act30.

In Act30, as described above, the processor 31 receives the image receipt data wirelessly transmitted from the receipt printer 10. Specifically, as described above, if the image receipt data wirelessly transmitted by the wireless communication unit 18 is received by the wireless communication unit 36, the processor 31 saves the image receipt data in the auxiliary storage unit 33. The processor 31 manages the image receipt data saved in the auxiliary storage unit 33 and the text receipt data, saved in the auxiliary storage unit 33, which is received in Act25, in association with each other.

If completing the reception of the image receipt data, the process returns to Act21.

The processor 31 determines Yes in Act28 if the second standby period is ended without receiving the instruction of the reception of the image. The process passes Act29 and Act30, and proceeds to Act21. In this case, the processor 31 receives no image receipt data and the information terminal 30 returns to the initial state of displaying the top screen.

In addition, if any one of operations is performed while the processor 31 is in the standby state in Act22 and Act23, the processor 31 determines Yes in Act23 and executes processing responding to the any one of operations performed. The any one of operations includes, for example, the display of the electronic receipt, the display of the image of the receipt indicated with the image receipt data, or the like based on the text receipt data saved in the auxiliary storage unit 33.

As described above, according to the receipt printer 10 of the present embodiment, since the text receipt data and the image receipt data can be directly delivered to the information terminal 30 carried by the shopper, the electronic receipt service can be provided at low cost compared with that of the conventional apparatus which requires the electronic receipt server and the like.

In addition, since the receipt printer 10 only receives the print request of the paper receipt from the POS terminal 20, the existing POS terminal 20 which does not have a function of the electronic receipt service can be used without any modification. In the existing POS system, the electronic receipt service can be provided in such a way that only an existing receipt printer is replaced with the receipt printer 10 described in the present embodiment.

In addition, since the text receipt data provided to the information terminal 30 from the receipt printer 10 includes the text data indicating the character string, the receipt printer 10 can easily be used, for example, for data aggregation by the household account book application program. Moreover, a function similar to that performed by the existing household accounting application program may be performed by processing according to the electronic receipt application program P11. In addition, since the text receipt data does not include the image data, the data amount thereof can be kept small. Therefore, the text receipt data can be transmitted in a short period of time even by the short-range wireless communication at a relatively low speed. Since the short-range wireless communication is used for transmission of the text receipt data, it is unnecessary to perform a setting for the communication in advance in both the receipt printer 10 and the information terminal 30. In addition, the holding operation of the information terminal 30 to the receipt printer 10 can be applied to an operation for instructing the transmission of the text receipt data and thus the operability of the information terminal can be simplified.

The image receipt data provided to the information terminal 30 by the receipt printer 10 indicates the appearance of the paper receipt. Therefore, the image indicated by the image receipt data is displayed on the touch panel 34 of the information terminal 30, and thus the shopper can confirm the contents of the receipt on the panel in a similar manner to a conventional manner of confirming the contents of the paper receipt. The receipt printer 10 uses wireless communication that requires the pairing data to transmit the image receipt data but has a longer communicable distance and a higher communication speed compared with those of the short-range wireless communication. Therefore, the image receipt data can be transmitted in a short period to the information terminal 30 located at a distance from the receipt printer 10. Thus, it is possible to transmit the image receipt data from the receipt printer 10 to the information terminal 30 while, for example, the shopper performs packing of the purchased commodities. The receipt printer 10 transmits the pairing data to the information terminal 30 together with the text receipt data by the short-range wireless communication. Therefore, there is no need to set the pairing data in advance in the information terminal 30.

According to the receipt printer 10, after the text receipt data is transmitted, the image receipt data is transmitted to the information terminal 30 only if the information terminal 30 is connected to the receipt printer through the wireless communication. Therefore, the shopper who does not need the image receipt data can leave the store without waiting for the image receipt data to be received by the information terminal 30.

In the embodiment, the following various modifications can be provided.

The process may proceed from Act25 to Act29 passing Act26 to Act28. That is, the image receipt data may be necessarily acquired by the information terminal 30. As described above, if the image receipt data is necessarily acquired by the information terminal 30, the pairing data in the information terminal 30 may be transmitted from the information terminal 30 to the receipt printer 10 through the short-range wireless communication. The receipt printer 10 may be wirelessly connected to the information terminal 30, using the pairing information and then transmit the image receipt data to the information terminal 30, using the wireless connection.

In the short-range wireless communication, the pairing data is transmitted/received and the text receipt data may be transmitted, using the wireless connection according to the pairing data.

The transmission of the image receipt data may be performed through the short-range wireless communication. If both the text receipt data and the image receipt data are transmitted through the short-range wireless communication, reception/transmission of the pairing data can be omitted.

The processor 11 may generate either one of the text receipt data and the image receipt data, and transmit the one to the information terminal 30.

The processor 11 may perform both printing of the paper receipt and transmission of at least one of the text receipt data and the image receipt data.

In order to adapt the display on the display device such as the touch panel 34, the processor 11 may generate the image receipt data for transmission to the information terminal 30 separately from data for printing by the print unit 15.

Instead of the POS terminal 20, the receipt printer 10 may be used by being connected to an electronic cash register.

Each function performed by the processor 11 executing the information processing can be partially or entirely performed by hardware executing the information processing not based on a program such as a logic circuit. In addition, each of the functions described above can also be performed by a combination of software control with hardware such as the logic circuit.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A receipt printer comprising:
a printing device;
a communication interface configured to receive print data;
a wireless communication module; and
a processor configured to:
control the printing device to print a receipt image on a receipt sheet based on the print data received by the communication interface;
generate text receipt data representative of text data included in the print data received by the communication interface; and
control the wireless communication module to wirelessly transmit the text receipt data.

2. The receipt printer according to claim 1, wherein the processor is configured to:
control the printing device to print the receipt image and the wireless communication module to not wirelessly transmit the text receipt data, when no wireless communication with an external communication terminal is established with the wireless communication module; and
control the printing device to not print the receipt image and the wireless communication module to wirelessly transmit the text receipt data, when a wireless communication with an external communication terminal is established with the wireless communication module.

3. The receipt printer according to claim 1, wherein the text receipt data indicates at least one of a store name, a store location, a store telephone number, a transaction date, a product name, and a product price.

4. The receipt printer according to claim 1, wherein the processor is further configured to compress the text receipt data, and the text receipt data transmitted by the wireless communication module is compressed text receipt data.

5. The receipt printer according to claim 1, wherein the processor is further configured to store the text receipt data in memory, and delete the text receipt data stored in the memory after determining that the receipt image is printed on the receipt sheet.

6. The receipt printer according to claim 1, wherein the processor is further configured to store the text receipt data in memory, and delete the text receipt data stored in the memory after determining that the wireless communication module transmits the text receipt data.

7. The receipt printer according to claim 1, wherein the text receipt data include no non-text image data.

8. The receipt printer according to claim 1, wherein the processor is configured to exclude predetermined text data from the print data received by the communication interface to generate the text receipt data.

9. The receipt printer according to claim 1, wherein the processor generates the text receipt data in a predetermined format.

10. A receipt printer comprising:
a printing device;
a communication interface configured to receive print data;
a wireless communication module; and
a processor configured to:
control the printing device to print a receipt image on a receipt sheet based on the print data received by the communication interface;
generate image receipt data indicative of a receipt image from the print data received by the communication interface; and
control the wireless communication module to wirelessly transmit the image receipt data.

11. The receipt printer according to claim 10, wherein the processor is configured to:
control the printing device to print the receipt image and the wireless communication module to not wirelessly transmit the image receipt data, when no wireless communication with an external communication terminal is established with the wireless communication module; and
control the printing device to not print the receipt image and the wireless communication module to wirelessly transmit the image receipt data, when a wireless communication with an external communication terminal is established with the wireless communication module.

12. The receipt printer according to claim 10, further comprising:
a second wireless communication module of a communication standard different from a communication standard of the wireless communication module, wherein
the processor is further configured to:
generate text receipt data representative of text data included in the print data received by the communication interface; and
control the second wireless communication module to wirelessly transmit the text receipt data.

13. The receipt printer according to claim 12, wherein the processor controls the second wireless communication module to wirelessly transmit the text receipt data after the wireless communication module transmits the image receipt data.

14. The receipt printer according to claim 12, wherein the processor is configured to:
control the printing device to print the receipt image and the second wireless communication module to not wirelessly transmit the text receipt data, when no wireless communication with an external communication terminal is established with the second wireless communication module; and
control the printing device to not print the receipt image and the second wireless communication module to wirelessly transmit the text receipt data, when a wireless communication with an external communication terminal is established with the second wireless communication module.

15. The receipt printer according to claim 12, wherein a communication range of the second wireless communication module is shorter than a communication range of the wireless communication module.

16. The receipt printer according to claim 12, wherein a communication data rate of the second wireless communication module is slower than a communication data rate of the wireless communication module.

17. The receipt printer according to claim 12, wherein the text receipt data indicates at least one of a store name, a store location, a store telephone number, a transaction date, a product name, and a product price.

18. The receipt printer according to claim 10, wherein the processor is further configured to compress the image receipt data, and the image receipt data transmitted by the wireless communication module is compressed image receipt data.

19. The receipt printer according to claim 10, wherein the processor is further configured to store the image receipt data in memory, and delete the image receipt data stored in the memory after determining that the receipt image is printed on the receipt sheet.

20. The receipt printer according to claim 10, wherein the processor is further configured to store the image receipt data in memory, and delete the image receipt data stored in the memory after determining that the wireless communication module transmits the image receipt data.
